(19) United States
(12) Patent Application Publication
(10) Pub. No.: US 2011/0178666 A1
(43) Pub. Date: Jul. 21, 2011

(54) Anti-rollback Control System for Motor Vehicles

(76) Inventor: ESSAM TAWFIK MARCUS, Morrisville, NC (US)

(21) Appl. No.: 13/076,293

(22) Filed: Mar. 30, 2011

Related U.S. Application Data
(63) Continuation-in-part of application No. 13/019,289, filed on Feb. 1, 2011.
Application No. 13/019,289 is a continuation-in-part of application No. 13/046,805, filed on Mar. 14, 2011.
Application No. 13/046,805 is a continuation-in-part of application No. 13/052,090, filed on Mar. 20, 2011.

(51) Int. Cl. B60L 15/20; G06F 19/00

(52) U.S. Cl. 701/22; 701/70

(57) ABSTRACT

The present invention provides an anti-rollback control system for use in a motor vehicle having a powertrain that includes an accelerator pedal that is mechanically incorporated with at least one position-sensing electronic device, for preventing undesired rolling of said vehicle on an incline. Said anti-rollback control system comprises: a tilt sensor; a sensor that detects a selected operating mode of the vehicle; at least one automated position-adjusting device; and a control module. The control module receives signals from the sensors, process said signals, and send instructions accordingly to the automated position-adjusting device to move the position-sensing electronic device(s) to a predetermined position according to which the vehicle's powertrain generates a preset amount of mechanical power sufficient to create a force, in the intended direction of movement of the vehicle, equivalent to, or bigger than, the gravitational force tending to roll the vehicle in the unwanted direction.

### CROSS-REFERENCE TO RELATED APPLICATIONS

This non-provisional utility patent application claims the benefit of one prior filed non-provisional application; the present application is a continuation-in-part of U.S. patent application Ser. No. 13/019,289, filed Feb. 1, 2011; U.S. patent application Ser. No. 13/046,805, filed Mar. 14, 2011; and U.S. patent application Ser. No. 13/052,090 filed Mar. 20, 2011, which are incorporated herein by reference in their entirety.

### TECHNICAL FIELD

The present invention relates to an anti-rollback control system for use in a motor vehicle to prevent undesired rolling of the vehicle on launching it on an incline.

### BACKGROUND ART

A typical problem that is encountered by motor vehicle operators, when they find themselves stopped on an incline and want to begin/resume moving again, is that the vehicle begins to roll in the unwanted direction when the operator does not responsively apply the accelerator pedal, with the rollback distance being a function of how quickly the operator transitions from depressing the brake pedal to applying the accelerator pedal.

In a vehicle having an automatic transmission, the powertrain is typically designed to provide a minimum amount of torque when the engine is running idle, which is referred to as creep torque. Although said creep torque prevents such a vehicle from rolling back on an incline having an angle of inclination of less than ±8 degrees, yet as the amount of creep torque can't be increased practically above a certain limit to avoid increasing the rate of gas consumption by the engine on idling, and to avoid excessive acceleration of the vehicle on starting it on a level, so creep torque generally fails to prevent the vehicle from rolling back on an incline having an angle of inclination bigger than ±8 degrees.

In electric and hybrid powertrain vehicles, as the electric motor is typically stopped when the vehicle is at rest, to reduce electric current consumption, so no creep torque is generated. This makes these vehicles susceptible for rolling back on launching them on inclines having smaller angles of inclination.

The prior art includes various systems and methods to prevent undesired rolling of a vehicle on launching it on an incline. One system, executed on a vehicle having a powertrain including an automatic transmission, senses vehicle roll via transmission sensors and engages a third clutching element in the automatic transmission to hold the transmission-output shaft from turning, and thus preventing vehicle rollback. A second system senses vehicle roll via wheel speed sensors or transmission sensors, and modulates the engine throttle to increase torque output of the powertrain to hold the vehicle stationary on a grade or to apply regenerative torque to resist the backward motion. Although these systems may accomplish the task of preventing vehicle rollback, yet their performance is unacceptable as they need the vehicle to actually start rolling back before they are activated, and due to the presence of a time lag between their activation and their actual stopping of the vehicle's rolling.

A third system senses the angle of inclination via inclinometers, grade sensors, or accelerometers, and modulates the amount of brake force applied to one or several vehicle wheels till enough torque is generated by the vehicle's engine and/or electric motor to resist the gravitational force tending to move the vehicle in the unwanted direction. Although this system may offer acceptable performance, yet as operating this system requires applying the brake force while the powertrain is being accelerated, so it results in shortening the service life of various components of the brake system. Also, as this system requires alternations in the design of the brake system, and necessitates the use of complex control strategies, so it is undesirably expensive to design, manufacture, and maintain.

A fourth system provides a method for reducing rollback by determining a grade; receiving a brake signal; calculating a brake release rate based on said brake signal; starting said engine based on said grade and said brake release rate; and setting an engine target RPM based on said grade to hold said vehicle without rollback when said vehicle is stopped and to creep said vehicle forward when said engine is started. Although this method provides improved performance compared to other anti-rollback methods and systems, yet as it relies on the vehicle's central control module for processing signals received from grade sensors, brake sensors, accelerator sensors, as well as all other powertrain components and performance sensors, so this adds a lot of complexity to the design and programming of said central control module, which makes the system undesirably expensive to produce and maintain, and makes it more prone to malfunctions during operation as a result of software errors.

Thus, there is still a need for an anti-rollback control system for use in electric powertrain vehicles, to prevent undesired rolling of said vehicles on launching them on inclines, with said anti-rollback control system being simple to design, economic to manufacture and maintain, and less prone to malfunctions during operation.

### BRIEF SUMMARY OF THE INVENTION

The present invention provides an anti-rollback control system for use in a motor vehicle, to prevent undesired rolling of said vehicle on launching it on an incline, with said anti-rollback control system being simple to design, economic to manufacture and maintain, and having a relatively simple mode of action which makes it less prone to malfunctions during operation.

As used herein, the term “module” refers to an application specific integrated circuit (ASIC), an electronic circuit, a processor (shared, dedicated, or group) and memory that execute one or more software or firmware programs, a combinational logic circuit, and/or other suitable components that provide the described functionality; the term “position-sensing electronic device” refers to any device constructed and configured to modulate its function based on the position of at least tow of its members relative to one another, with said members being movable relative to one another on operating the device, and with non examples or these devices including position sensors, potentiometers, and rheostats, with said electronic device being connected to at least one of the vehicle components by at least one electrical circuit; the term “mechanically incorporated with” refers to mechanically linking or mechanically integrating the movable member(s) of a first device with the movable member(s) of a second device, so that any movement of the movable member(s) of the first device results in a correlated movement of the movable member(s) of the second device; the term “horizontal plane” refers to a plane perpendicular to the direction of the gravitational force at a given point; the term “uphill incline” refers to an incline on which a vehicle is oriented so that its leading end is facing upward, with the level of the horizontal plane on which the leading end of the vehicle lies being higher than the level of the horizontal plane on which the trailing end of the vehicle lies; the term “downhill incline” refers to an incline on which a vehicle is oriented so that its leading end is facing downward, with the level of the horizontal plane on which the leading end of the vehicle lies being lower than the level of the horizontal plane on which the trailing end of the vehicle lies; the term “operating mode selecting device” refers to and includes any device used by a vehicle operator to select an intended vehicle operating mode, with non limiting examples of operating mode selecting devices including: automatic transmission systems, automated transmission systems, gear selectors, drive mode selectors, and operating mode selectors; the term “selected operating mode of the vehicle” refers to any one of the vehicle operating modes that might be selected by a vehicle operator, which includes, but not limited to, at least one forward driving mode (D) and at least one reverse driving mode (R); the term “non-moving operating mode” refers to any one of the vehicle operating modes, other than forward driving mode(s) and reverse driving mode(s), that might be selected by a vehicle operator, which includes, but not limited to, Parking mode (P) and Neutral mode (N); and the term “tilt sensor” refers to and includes any device used for measuring the angle of inclination between two planes, or the angle of inclination between an axis and a plane, with non limiting examples including: inclinometers, grade sensors, and accelerometers.

Accordingly, in a motor vehicle having a powertrain that includes an ICE (internal combustion engine) and/or an electric motor, and an accelerator pedal that is mechanically incorporated with at least one position-sensing electronic device, with the amount of fuel supplied to said ICE and/or the amount of electric power delivered to said electric motor, and hence the amount of mechanical power generated by said powertrain, being a function of the position of at least one movable component of the said at least one position-sensing electronic device, the present invention provides an anti-rollback control system for preventing undesired rolling of said motor vehicle on beginning/resuming the movement of the vehicle after stopping it on an incline.

In a preferred embodiment, the anti-rollback control system comprises: at least one tilt sensor that detects an angle of inclination of the vehicle's longitudinal axis with reference to the horizontal plane and generates signals accordingly; at least one sensor that detects a selected operating mode of the vehicle and generates signals accordingly; at least one automated position-adjusting device for adjusting the position of at least one movable component of the said vehicle's at least one position-sensing electronic device; and a control module constructed and configured for receiving the signals generated by said tilt sensor and said sensor for detecting the selected operating mode of the vehicle, processing said received signals, and sending instructions accordingly to the said at least one automated position-adjusting device to cause at least one movable component of the said at least one position-sensing electronic device to move to a predetermined position according to which a preset amount of fuel is supplied to said ICE and/or a preset amount of electric power is delivered to said electric motor, and hence a preset amount of mechanical power is generated by said powertrain, with said preset amount of mechanical power being sufficient to create a force, in the intended direction of movement of the vehicle, equivalent to, or bigger than, the gravitational force tending to roll the vehicle in the unwanted direction. In a preferred embodiment, the said position-sensing electronic device is a potentiometer. In another preferred embodiment, the said at least one automated position-adjusting device is mechanically incorporated with the said at least one position-sensing electronic device. In another preferred embodiment, the said control module is constructed and configured to send instructions to move the said at least one automated position-adjusting device to its idle position when the said received signals indicate selecting a non-moving operating mode by the vehicle operator. In yet another preferred embodiment, the said control module is constructed and configured to send instructions to move the said at least one automated position-adjusting device to its idle position when the said signals received from the said at least one tilt sensor indicate operating the vehicle on a horizontally oriented surface.

In one feature, the said anti-rollback control system further comprises at least one brake pedal actuated device constructed and configured to cause an interruption in the continuity of at least one electrical circuit that includes the said at least one position-sensing electronic device and at least one of the vehicle components once the brake pedal reaches a predetermined position. In a preferred embodiment, the said brake pedal actuated device is an electrical switch. In another preferred embodiment, the said brake pedal actuated device includes a first brake pedal actuated electrical switch; a second solenoid actuated switch; and a second electrical circuit that connects the first brake pedal actuated electrical switch to the second solenoid actuated switch, with the first brake pedal actuated electrical switch being constructed and configured to close the said second electrical circuit once the brake pedal reaches a predetermined position, and with the second solenoid actuated switch being constructed and configured to open the said at least one electrical circuit including the at least one position-sensing electronic device and at least one of the vehicle components once the second electrical circuit is closed. In yet another preferred embodiment, the said brake pedal actuated device comprises a position sensor that detects a position of the brake pedal and generates signals accordingly; a control module; and at least one solenoid actuated switch included within the said at least one electrical circuit, with the said control module being constructed and configured to receive the signals generated by said position sensor, process said received signals, and send instructions to said at least one solenoid actuated switch to open the said at least one electrical circuit including the at least one position-sensing electronic device and at least one of the vehicle components once the brake pedal reaches a predetermined position. In another preferred embodiment, the said anti-rollback control system is used in an electric vehicle with the said at least one electrical circuit being selected so that any interruption in its continuity leads to cutting off the electric current from the vehicle's driving electric motor(s).

In another feature, the said anti-rollback control system further comprises at least one pressure-activated device that detects the hydrostatic pressure of a working fluid within the vehicle's brake system, with said at least one pressure-activated device being constructed and configured to cause an interruption in the continuity of at least one electrical circuit that includes the said at least one position-sensing electronic device and at least one of the vehicle components once the hydrostatic pressure within the said brake system reaches a predetermined level. In a preferred embodiment, the said pressure-activated device actuates an electrical switch that causes an interruption in the continuity of the said at least one electrical circuit that includes the said at least one position-sensing electronic device and at least one of the vehicle components once the hydrostatic pressure within the said brake system reaches a predetermined level. In another preferred embodiment, the said pressure-activated device actuates a first electrical switch constructed and configured to close a second electrical circuit once the hydrostatic pressure within the said brake system reaches a predetermined level, with the said second electrical circuit being connected to a second solenoid actuated switch constructed and configured to open the said at least one electrical circuit including the at least one position-sensing electronic device and at least one of the vehicle components once the said second electrical circuit is closed. In yet another preferred embodiment, the said pressure-activated device includes a pressure sensor that detects the hydrostatic pressure of a working fluid within the vehicle's brake system and generates signals accordingly; a control module; and at least one solenoid actuated switch included within the said at least one electrical circuit, with the said control module being constructed and configured to receive the signals generated by said pressure sensor, process said received signals, and send instructions to said at least one solenoid actuated switch to open the said at least one electrical circuit including the at least one position-sensing electronic device and at least one of the vehicle components once the hydrostatic pressure within the said brake system reaches a predetermined level. In another preferred embodiment, the said anti-rollback control system is used in an electric vehicle with the said at least one electrical circuit being selected so that any interruption in its continuity leads to cutting off the electric current from the vehicle's driving electric motor(s).

In yet another feature, the said anti-rollback control system further comprises a brake pedal actuated device constructed and configured to cause closure of an electrical circuit connected to at least one component of the vehicle's powertrain once the brake pedal reaches a predetermined position, with the said component of the vehicle's powertrain being constructed and configured to cause at least one component of the vehicle's powertrain to move to its idle operating position once the said electrical circuit is closed. In a preferred embodiment, the brake pedal actuated device is an electrical switch constructed and configured to close the said electrical circuit connected to at least one component of the vehicle's powertrain once the brake pedal reaches a predetermined position. In another preferred embodiment, the brake pedal actuated device includes a first brake pedal actuated electrical switch; a second solenoid actuated switch; and a second electrical circuit that connects the first brake pedal actuated electrical switch to the second solenoid actuated switch, with the first brake pedal actuated electrical switch being constructed and configured to close the said second electrical circuit once the brake pedal reaches a predetermined position, and with the second solenoid actuated switch being constructed and configured to close the said electrical circuit connected to at least one component of the vehicle's powertrain once the second electrical circuit is closed. In yet another preferred embodiment, the brake pedal actuated device comprises a position sensor that detects a position of the brake pedal and generates signals accordingly; a control module; and a solenoid actuated switch included within the said electrical circuit, with the said control module being constructed and configured to receive the signals generated by said position sensor, process said received signals, and send instructions to said solenoid actuated switch to close the said electrical circuit connected to at least one component of the vehicle's powertrain once the brake pedal reaches a predetermined position. This feature enables moving at least one component of the vehicle's powertrain to its idle operating position when the vehicle brakes are applied.

In another feature, the said anti-rollback control system further comprises a pressure-activated device that detects the hydrostatic pressure of a working fluid within the vehicle's brake system, with said pressure-activated device being constructed and configured to cause closure of an electrical circuit connected to at least one component of the vehicle's powertrain once the hydrostatic pressure within the said brake system reaches a predetermined level, with the said component of the vehicle's powertrain being constructed and configured to cause at least one component of the vehicle's powertrain to move to its idle operating position once the said electrical circuit is closed. In a preferred embodiment, the pressure-activated device actuates an electrical switch constructed and configured to close the said electrical circuit connected to at least one component of the vehicle's powertrain once the hydrostatic pressure within the said brake system reaches a predetermined level. In another preferred embodiment, the pressure-activated device actuates a first electrical switch constructed and configured to close a second electrical circuit once the hydrostatic pressure within the said brake system reaches a predetermined level, with the said second electrical circuit being connected to a second solenoid actuated switch constructed and configured to close the said electrical circuit connected to at least one component of the vehicle's powertrain once the said second electrical circuit is closed. In yet another preferred embodiment, the pressure-activated device includes a pressure sensor that detects the hydrostatic pressure of a working fluid within the vehicle's brake system and generates signals accordingly; a control module; and a solenoid actuated switch included within the said electrical circuit, with the said control module being constructed and configured to receive the signals generated by said pressure sensor, process said received signals, and send instructions to said solenoid actuated switch to close the said electrical circuit connected to at least one component of the vehicle's powertrain once the hydrostatic pressure within the said brake system reaches a predetermined level. This feature enables moving at least one component of the vehicle's powertrain to its idle operating position when the vehicle brakes are applied.

In yet another feature, the said anti-rollback control system further comprises at least one sensor that detects the position of the vehicle's brake pedal and sends signals accordingly to said control module, with said control module being constructed and configured to begin sending the said instructions to said at least one automated position-adjusting device once the brake pedal reaches a predetermined position. In a preferred embodiment, the control module is configured to begin sending the said instructions once the vehicle's operator begins to release the brake pedal. In another preferred embodiment, the brake pedal position at which the control module is configured to begin sending said instructions is determined in correlation with the said measured angle of inclination. In yet another preferred embodiment, the control module is configured to send signals to move the at least one automated position-adjusting device to its idle position once the brake pedal reaches a predetermined position.

In another feature, the said anti-rollback control system further comprises at least one sensor that detects the hydrostatic pressure of a working fluid at at least one point within the vehicle's brake system and sends signals accordingly to said control module, with said control module being constructed and configured to begin sending the said instructions to said at least one automated position-adjusting device once the hydrostatic pressure within the vehicle's brake system drops to a predetermined level. In a preferred embodiment, the said predetermined brake pressure level at which said control module is configured to begin sending said instructions to the at least one automated position-adjusting device is determined in correlation with the said measured angle of inclination. In another preferred embodiment, the control module is configured to send signals to move the at least one automated position-adjusting device to its idle position once the hydrostatic pressure within the vehicle's brake system reaches a predetermined level.

Still in another feature, the said anti-rollback control system further comprises at least one sensor for generating a signal indicative of the speed of said vehicle and sending signals accordingly to said control module, with said control module being constructed and configured for processing the received signals, along with said signals received from said tilt sensor and said sensor for detecting the selected operating mode of the vehicle, and sending instructions accordingly to said at least one automated position-adjusting device. In a preferred embodiment, the control module is constructed and configured to send the said instructions when the speed of the vehicle is below a predetermined speed, and stops sending the said instructions once the speed of the vehicle exceed the said predetermined speed.

In another feature, the vehicle's maximum loading weight is being taken into account while processing said received signals by said control module.

In still another feature, the said anti-rollback control system further comprises at least one weight-measuring device that measures the weight of said vehicle and sends signals accordingly to said control module, with said control module being constructed and configured for processing the received signals, along with said signals received from said tilt sensor and said sensor for detecting the selected operating mode of the vehicle, and sending instructions accordingly to said at least one automated position-adjusting device. In a preferred embodiment, the said weight-measuring device is one, or more than one, load cell positioned at any point underneath the vehicle's body.

In another feature, the said control module is a multi-task module. In a preferred embodiment, the said anti-rollback control system is used in a vehicle having an Electronic Control Unit (ECU), with the said control module being integrated within the said ECU.

In yet another feature, the said signals generated by the tilt sensor and received by the control module are repeated at equal intervals, to accommodate for any changes in the signals generated by any of the other before mentioned sensors.

In a preferred embodiment, the said at least one automated position-adjusting device includes: a cam and follower mechanism; and a stepper motor, with the said follower being mechanically incorporated with at least one movable component of the said at least one position-sensing electronic device so that the movement of the follower is transmitted, directly or indirectly, to the movable component(s) of the said at least one position-sensing electronic device, and with the movement of the said cam and follower mechanism being controlled by the said stepper motor in accordance with said instructions sent by said control module.

Also, the anti-rollback control system of the present invention is functional for preventing undesired backward rolling of said vehicle on beginning/resuming its forward movement after stopping it on an uphill incline, as well as preventing undesired forward rolling of said vehicle on beginning/resuming its backward movement after stopping it on a downhill incline.

In another feature, the anti-rollback control system of the present invention is operable for preventing undesired rolling of a motor vehicle on beginning/resuming the movement of said vehicle after stopping it on anyone of a number of inclines, with each of the said inclines having a different angle of inclination. In a preferred embodiment, each individual angle of inclination measured by the said tilt sensor, on operating the vehicle on each of the said inclines, is being correlated with a different set of instructions sent by said control module. In another preferred embodiment, the angles of inclinations of the said inclines are functionally grouped into at least one range of angles, with each individual angle of inclination measured by the said tilt sensor, on operating the vehicle on each of the said inclines, being correlated with a predetermined set of instructions sent by said control module based on the range of angles within which said measured angle of inclination lies.

The present invention also provides a method for preventing undesired rolling of a motor vehicle having a powertrain that includes an ICE (internal combustion engine) and/or an electric motor, and an accelerator pedal that is mechanically incorporated with at least one position-sensing electronic device, with the amount of fuel supplied to said ICE and/or the amount of electric power delivered to said electric motor, and hence the amount of mechanical power generated by said powertrain, being a function of the position of at least one movable component of the said at least one position-sensing electronic device, on beginning/resuming the movement of the said vehicle after stopping it on an incline. Said method comprises: providing an automated device for adjusting the position of at least one movable component of the said at least one position-sensing electronic device; measuring the angle of inclination of the vehicle's longitudinal axis with reference to the horizontal plane and generating signals accordingly; detecting a selected operating mode of the vehicle and generating signals accordingly; processing said generated signals; and sending instructions accordingly to said automated device provided for adjusting the position of at least one movable component of the said at least one position-sensing electronic device to adjust the position of the said movable component(s) accordingly.

In one feature, the said method further comprises providing at least one brake pedal actuated device constructed and configured to cause an interruption in the continuity of at least one electrical circuit that includes the said at least one position-sensing electronic device and at least one of the vehicle components once the brake pedal reaches a predetermined position. In a preferred embodiment, the said method is used in an electric vehicle with the said at least one electrical circuit being selected so that any interruption in its continuity leads to cutting off the electric current from the vehicle's driving electric motor(s).

In another feature, the said method further comprises providing at least one pressure-activated device that detects the hydrostatic pressure of a working fluid within the vehicle's brake system, with said pressure-activated device being constructed and configured to cause an interruption in the continuity of at least one electrical circuit that includes the said at least one position-sensing electronic device and at least one of the vehicle components once the hydrostatic pressure within the said brake system reaches a predetermined level. In a preferred embodiment, the said method is used in an electric vehicle with the said at least one electrical circuit being selected so that any interruption in its continuity leads to cutting off the electric current from the vehicle's driving electric motor(s).

In yet another feature, the said method further comprises providing a brake pedal actuated device constructed and configured to cause closure of an electrical circuit connected to at least one component of the vehicle's powertrain once the brake pedal reaches a predetermined position, with the said component of the vehicle's powertrain being constructed and configured to cause at least one component of the vehicle's powertrain to move to its idle operating position once the said electrical circuit is closed.

In another feature, the said method further comprises providing a pressure-activated device that detects the hydrostatic pressure of a working fluid within the vehicle's brake system, with said pressure-activated device being constructed and configured to cause closure of an electrical circuit connected to at least one component of the vehicle's powertrain once the hydrostatic pressure within the said brake system reaches a predetermined level, with the said component of the vehicle's powertrain being constructed and configured to cause at least one component of the vehicle's powertrain to move to its idle operating position once the said electrical circuit is closed.

In yet another feature, the said method further comprises detecting the position of the vehicle's brake pedal and generating signals accordingly, with said generated signals being processed along with said signals generated in correlation with said measured angle of inclination of the vehicle and said signals generated in correlation with said selected operating mode of the vehicle, and with said sent instructions being configured accordingly.

In another feature, the said method further comprises detecting the hydrostatic pressure of a working fluid within the vehicle's brake system and generating signals accordingly, with said generated signals being processed along with said signals generated in correlation with said measured angle of inclination of the vehicle and said signals generated in correlation with said selected operating mode of the vehicle, and with said sent instructions being configured accordingly.

In yet another feature, the said method further comprises measuring the speed of the said vehicle and generating signals accordingly, with said generated signals being processed along with said signals generated in correlation with said measured angle of inclination of the vehicle and said signals generated in correlation with said selected operating mode of the vehicle, and with said sent instructions being configured accordingly.

In still another feature, the said method further comprises measuring the weight of the vehicle and generating signals accordingly, with said generated signals being processed along with said signals generated in correlation with said measured angle of inclination of the vehicle and said signals generated in correlation with said selected operating mode of the vehicle, and with said sent instructions being configured accordingly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The description of the objects, features and advantages of the present invention will be more fully appreciated by reference to the following detailed description of the exemplary embodiments in accordance with the accompanying drawings, wherein:

FIG. 1 is a functional block diagram of a vehicle including a preferred embodiment of an anti-rollback control system in accordance with the present invention;

FIG. 2 is a functional block diagram of a vehicle including another preferred embodiment of an anti-rollback control system in accordance with the present invention;

FIG. 3 is a flowchart illustrating exemplary steps executed by a control module in accordance with the present invention;

FIG. 4-a and FIG. 4-b are flowcharts illustrating exemplary steps executed by the layers of a multi-task control module in accordance with the present invention;

FIG. 5-a, FIG. 5-b, and FIG. 5-c are flowcharts illustrating exemplary steps executed by the layers of another multi-task control module in accordance with the present invention; and

FIG. 6 is a functional block diagram of an accelerator pedal in a plurality of exemplary operating positions in accordance with the anti-rollback control system of the present invention.

### DETAILED DESCRIPTION OF THE INVENTION

The present invention provides an anti-rollback control system for use in a motor vehicle, to prevent undesired rolling of said vehicle on launching it on an incline, with said anti-rollback control system being simple to design, economic to manufacture and maintain, and having a relatively simple mode of action which makes it less prone to malfunctions during operation.

As used herein, the term “module” refers to an application specific integrated circuit (ASIC), an electronic circuit, a processor (shared, dedicated, or group) and memory that execute one or more software or firmware programs, a combinational logic circuit, and/or other suitable components that provide the described functionality; the term “position-sensing electronic device” refers to an electronic device constructed and configured to provide position information indicative of the position of two members of the device relative to one another, e.g. a position sensor, or refers to an electronic device constructed and configured to control the flow of electric power within an electrical circuit based on the position of two members of the device relative to one another, e.g. a potentiometer or a rheostat, with said electronic device being connected to at least one of the vehicle components by at least one electrical circuit; the term “mechanically incorporated with” refers to mechanically linking or mechanically integrating the movable member(s) of a first device with the movable member(s) of a second device, so that any movement of the movable member(s) of the first device results in a correlated movement of the movable member(s) of the second device; the term “horizontal plane” refers to a plane perpendicular to the direction of the gravitational force at a given point; the term “uphill incline” refers to an incline on which a vehicle is oriented so that its leading end is facing upward, with the level of the horizontal plane on which the leading end of the vehicle lies being higher than the level of the horizontal plane on which the trailing end of the vehicle lies; the term “downhill incline” refers to an incline on which a vehicle is oriented so that its leading end is facing downward, with the level of the horizontal plane on which the leading end of the vehicle lies being lower than the level of the horizontal plane on which the trailing end of the vehicle lies; the term “operating mode selecting device” refers to and includes any device used by a vehicle operator to select an intended vehicle operating mode, with non limiting examples of operating mode selecting devices including: automatic transmission systems, automated transmission systems, gear selectors, drive mode selectors, and operating mode selectors; the term “selected operating mode of the vehicle” refers to any one of the vehicle operating modes that might be selected by a vehicle operator, which includes, but not limited to, at least one forward driving mode (D) and at least one reverse driving mode (R); the term “non-moving operating mode” refers to any one of the vehicle operating modes, other than forward driving mode(s) and reverse driving mode(s), that might be selected by a vehicle operator, which includes, but not limited to, Parking mode (P) and Neutral mode (N); and the term “tilt sensor” refers to and includes any device used for measuring the angle of inclination between two planes, or the angle of inclination between an axis and a plane, with non limiting examples including: inclinometers, grade sensors, and accelerometers.

Accordingly, in a motor vehicle having a powertrain that includes an ICE (internal combustion engine) and/or an electric motor, and an accelerator pedal that is mechanically incorporated with at least one position-sensing electronic device, with the amount of fuel supplied to said ICE and/or the amount of electric power delivered to said electric motor, and hence the amount of mechanical power generated by said powertrain, being a function of the position of at least one movable component of the said at least one position-sensing electronic device, the present invention provides an anti-rollback control system for preventing undesired rolling of said motor vehicle on beginning/resuming the movement of the vehicle after stopping it on an incline.

In a preferred embodiment, the anti-rollback control system comprises: at least one tilt sensor that detects an angle of inclination of the vehicle's longitudinal axis with reference to the horizontal plane and generates signals accordingly; at least one sensor that detects a selected operating mode of the vehicle and generates signals accordingly; at least one automated position-adjusting device for adjusting the position of at least one movable component of the said vehicle's at least one position-sensing electronic device; and a control module constructed and configured for receiving the signals generated by said tilt sensor and said sensor for detecting the selected operating mode of the vehicle, processing said received signals, and sending instructions accordingly to the said at least one automated position-adjusting device to cause at least one movable component of the said at least one position-sensing electronic device to move to a predetermined position according to which a preset amount of fuel is supplied to said ICE and/or a preset amount of electric power is delivered to said electric motor, and hence a preset amount of mechanical power is generated by said powertrain, with said preset amount of mechanical power being sufficient to create a force, in the intended direction of movement of the vehicle, equivalent to, or bigger than, the gravitational force tending to roll the vehicle in the unwanted direction. In a preferred embodiment, the said position-sensing electronic device is a potentiometer. In another preferred embodiment, the said at least one automated position-adjusting device is mechanically incorporated with the said at least one position-sensing electronic device. In another preferred embodiment, the said control module is constructed and configured to send instructions to move the said at least one automated position-adjusting device to its idle position when the said received signals indicate selecting a non-moving operating mode by the vehicle operator. In yet another preferred embodiment, the said control module is constructed and configured to send instructions to move the said at least one automated position-adjusting device to its idle position when the said signals received from the said at least one tilt sensor indicate operating the vehicle on a horizontally oriented surface.

In one feature, the said anti-rollback control system further comprises at least one brake pedal actuated device constructed and configured to cause an interruption in the continuity of at least one electrical circuit that includes the said at least one position-sensing electronic device and at least one of the vehicle components once the brake pedal reaches a predetermined position. In a preferred embodiment, the said brake pedal actuated device is an electrical switch.

In another preferred embodiment, the said brake pedal actuated device includes a first brake pedal actuated electrical switch; a second solenoid actuated switch; and a second electrical circuit that connects the first brake pedal actuated electrical switch to the second solenoid actuated switch, with the first brake pedal actuated electrical switch being constructed and configured to close the said second electrical circuit once the brake pedal reaches a predetermined position, and with the second solenoid actuated switch being constructed and configured to open the said at least one electrical circuit including the at least one position-sensing electronic device and at least one of the vehicle components once the second electrical circuit is closed. In yet another preferred embodiment, the said brake pedal actuated device comprises a position sensor that detects a position of the brake pedal and generates signals accordingly; a control module; and at least one solenoid actuated switch included within the said at least one electrical circuit, with the said control module being constructed and configured to receive the signals generated by said position sensor, process said received signals, and send instructions to said at least one solenoid actuated switch to open the said at least one electrical circuit including the at least one position-sensing electronic device and at least one of the vehicle components once the brake pedal reaches a predetermined position. In another preferred embodiment, the said anti-rollback control system is used in an electric vehicle with the said at least one electrical circuit being selected so that any interruption in its continuity leads to cutting off the electric current from the vehicle's driving electric motor(s).

In another feature, the said anti-rollback control system further comprises at least one pressure-activated device that detects the hydrostatic pressure of a working fluid within the vehicle's brake system, with said at least one pressure-activated device being constructed and configured to cause an interruption in the continuity of at least one electrical circuit that includes the said at least one position-sensing electronic device and at least one of the vehicle components once the hydrostatic pressure within the said brake system reaches a predetermined level. In a preferred embodiment, the said pressure-activated device actuates an electrical switch that causes an interruption in the continuity of the said at least one electrical circuit that includes the said at least one position-sensing electronic device and at least one of the vehicle components once the hydrostatic pressure within the said brake system reaches a predetermined level. In another preferred embodiment, the said pressure-activated device actuates a first electrical switch constructed and configured to close a second electrical circuit once the hydrostatic pressure within the said brake system reaches a predetermined level, with the said second electrical circuit being connected to a second solenoid actuated switch constructed and configured to open the said at least one electrical circuit including the at least one position-sensing electronic device and at least one of the vehicle components once the said second electrical circuit is closed. In yet another preferred embodiment, the said pressure-activated device includes a pressure sensor that detects the hydrostatic pressure of a working fluid within the vehicle's brake system and generates signals accordingly; a control module; and at least one solenoid actuated switch included within the said at least one electrical circuit, with the said control module being constructed and configured to receive the signals generated by said pressure sensor, process said received signals, and send instructions to said at least one solenoid actuated switch to open the said at least one electrical circuit including the at least one position-sensing electronic device and at least one of the vehicle components once the hydrostatic pressure within the said brake system reaches a predetermined level. In another preferred embodiment, the said anti-rollback control system is used in an electric vehicle with the said at least one electrical circuit being selected so that any interruption in its continuity leads to cutting off the electric current from the vehicle's driving electric motor(s).

In yet another feature, the said anti-rollback control system further comprises a brake pedal actuated device constructed and configured to cause closure of an electrical circuit connected to at least one component of the vehicle's powertrain once the brake pedal reaches a predetermined position, with the said component of the vehicle's powertrain being constructed and configured to cause at least one component of the vehicle's powertrain to move to its idle operating position once the said electrical circuit is closed. In a preferred embodiment, the brake pedal actuated device is an electrical switch constructed and configured to close the said electrical circuit connected to at least one component of the vehicle's powertrain once the brake pedal reaches a predetermined position. In another preferred embodiment, the brake pedal actuated device includes a first brake pedal actuated electrical switch; a second solenoid actuated switch; and a second electrical circuit that connects the first brake pedal actuated electrical switch to the second solenoid actuated switch, with the first brake pedal actuated electrical switch being constructed and configured to close the said second electrical circuit once the brake pedal reaches a predetermined position, and with the second solenoid actuated switch being constructed and configured to close the said electrical circuit connected to at least one component of the vehicle's powertrain once the second electrical circuit is closed. In yet another preferred embodiment, the brake pedal actuated device comprises a position sensor that detects a position of the brake pedal and generates signals accordingly; a control module; and a solenoid actuated switch included within the said electrical circuit, with the said control module being constructed and configured to receive the signals generated by said position sensor, process said received signals, and send instructions to said solenoid actuated switch to close the said electrical circuit connected to at least one component of the vehicle's powertrain once the brake pedal reaches a predetermined position. This feature enables moving at least one component of the vehicle's powertrain to its idle operating position when the vehicle brakes are applied.

In another feature, the said anti-rollback control system further comprises a pressure-activated device that detects the hydrostatic pressure of a working fluid within the vehicle's brake system, with said pressure-activated device being constructed and configured to cause closure of an electrical circuit connected to at least one component of the vehicle's powertrain once the hydrostatic pressure within the said brake system reaches a predetermined level, with the said component of the vehicle's powertrain being constructed and configured to cause at least one component of the vehicle's powertrain to move to its idle operating position once the said electrical circuit is closed. In a preferred embodiment, the pressure-activated device actuates an electrical switch constructed and configured to close the said electrical circuit connected to at least one component of the vehicle's powertrain once the hydrostatic pressure within the said brake system reaches a predetermined level. In another preferred embodiment, the pressure-activated device actuates a first electrical switch constructed and configured to close a second electrical circuit once the hydrostatic pressure within the said brake system reaches a predetermined level, with the said second electrical circuit being connected to a second solenoid actuated switch constructed and configured to close the said electrical circuit connected to at least one component of the vehicle's powertrain once the said second electrical circuit is closed. In yet another preferred embodiment, the pressure-activated device includes a pressure sensor that detects the hydrostatic pressure of a working fluid within the vehicle's brake system and generates signals accordingly; a control module; and a solenoid actuated switch included within the said electrical circuit, with the said control module being constructed and configured to receive the signals generated by said pressure sensor, process said received signals, and send instructions to said solenoid actuated switch to close the said electrical circuit connected to at least one component of the vehicle's powertrain once the hydrostatic pressure within the said brake system reaches a predetermined level. This feature enables moving at least one component of the vehicle's powertrain to its idle operating position when the vehicle brakes are applied.

In yet another feature, the said anti-rollback control system further comprises at least one sensor that detects the position of the vehicle's brake pedal and sends signals accordingly to said control module, with said control module being constructed and configured to begin sending the said instructions to said at least one automated position-adjusting device once the brake pedal reaches a predetermined position. In a preferred embodiment, the control module is configured to begin sending the said instructions once the vehicle's operator begins to release the brake pedal. In another preferred embodiment, the brake pedal position at which the control module is configured to begin sending said instructions is determined in correlation with the said measured angle of inclination. In yet another preferred embodiment, the control module is configured to send signals to move the at least one automated position-adjusting device to its idle position once the brake pedal reaches a predetermined position.

In another feature, the said anti-rollback control system further comprises at least one sensor that detects the hydrostatic pressure of a working fluid at at least one point within the vehicle's brake system and sends signals accordingly to said control module, with said control module being constructed and configured to begin sending the said instructions to said at least one automated position-adjusting device once the hydrostatic pressure within the vehicle's brake system drops to a predetermined level. In a preferred embodiment, the said predetermined brake pressure level at which said control module is configured to begin sending said instructions to the at least one automated position-adjusting device is determined in correlation with the said measured angle of inclination. In another preferred embodiment, the control module is configured to send signals to move the at least one automated position-adjusting device to its idle position once the hydrostatic pressure within the vehicle's brake system reaches a predetermined level.

Still in another feature, the said anti-rollback control system further comprises at least one sensor for generating a signal indicative of the speed of said vehicle and sending signals accordingly to said control module, with said control module being constructed and configured for processing the received signals, along with said signals received from said tilt sensor and said sensor for detecting the selected operating mode of the vehicle, and sending instructions accordingly to said at least one automated position-adjusting device. In a preferred embodiment, the control module is constructed and configured to send the said instructions when the speed of the vehicle is below a predetermined speed, and stops sending the said instructions once the speed of the vehicle exceed the said predetermined speed.

In another feature, the vehicle's maximum loading weight is being taken into account while processing said received signals by said control module.

In still another feature, the said anti-rollback control system further comprises at least one weight-measuring device that measures the weight of said vehicle and sends signals accordingly to said control module, with said control module being constructed and configured for processing the received signals, along with said signals received from said tilt sensor and said sensor for detecting the selected operating mode of the vehicle, and sending instructions accordingly to said at least one automated position-adjusting device. In a preferred embodiment, the said weight-measuring device is one, or more than one, load cell positioned at any point underneath the vehicle's body.

In another feature, the said control module is a multi-task module. In a preferred embodiment, the said anti-rollback control system is used in a vehicle having an Electronic Control Unit (ECU), with the said control module being integrated within the said ECU.

In yet another feature, the said signals generated by the tilt sensor and received by the control module are repeated at equal intervals, to accommodate for any changes in the signals generated by any of the other before mentioned sensors.

In a preferred embodiment, the said at least one automated position-adjusting device includes: a cam and follower mechanism; and a stepper motor, with the said follower being mechanically incorporated with at least one movable component of the said at least one position-sensing electronic device so that the movement of the follower is transmitted, directly or indirectly, to the movable component(s) of the said at least one position-sensing electronic device, and with the movement of the said cam and follower mechanism being controlled by the said stepper motor in accordance with said instructions sent by said control module.

Also, the anti-rollback control system of the present invention is functional for preventing undesired backward rolling of said vehicle on beginning/resuming its forward movement after stopping it on an uphill incline, as well as preventing undesired forward rolling of said vehicle on beginning/resuming its backward movement after stopping it on a downhill incline.

In another feature, the anti-rollback control system of the present invention is operable for preventing undesired rolling of a motor vehicle on beginning/resuming the movement of said vehicle after stopping it on anyone of a number of inclines, with each of the said inclines having a different angle of inclination. In a preferred embodiment, each individual angle of inclination measured by the said tilt sensor, on operating the vehicle on each of the said inclines, is being correlated with a different set of instructions sent by said control module. In another preferred embodiment, the angles of inclinations of the said inclines are functionally grouped into at least one range of angles, with each individual angle of inclination measured by the said tilt sensor, on operating the vehicle on each of the said inclines, being correlated with a predetermined set of instructions sent by said control module based on the range of angles within which said measured angle of inclination lies.

The present invention also provides a method for preventing undesired rolling of a motor vehicle having a powertrain that includes an ICE (internal combustion engine) and/or an electric motor, and an accelerator pedal that is mechanically incorporated with at least one position-sensing electronic device, with the amount of fuel supplied to said ICE and/or the amount of electric power delivered to said electric motor, and hence the amount of mechanical power generated by said powertrain, being a function of the position of at least one movable component of the said at least one position-sensing electronic device, on beginning/resuming the movement of the said vehicle after stopping it on an incline. Said method comprises: providing an automated device for adjusting the position of at least one movable component of the said at least one position-sensing electronic device; measuring the angle of inclination of the vehicle's longitudinal axis with reference to the horizontal plane and generating signals accordingly; detecting a selected operating mode of the vehicle and generating signals accordingly; processing said generated signals; and sending instructions accordingly to said automated device provided for adjusting the position of at least one movable component of the said at least one position-sensing electronic device to adjust the position of the said movable component(s) accordingly.

In one feature, the said method further comprises providing at least one brake pedal actuated device constructed and configured to cause an interruption in the continuity of at least one electrical circuit that includes the said at least one position-sensing electronic device and at least one of the vehicle components once the brake pedal reaches a predetermined position. In a preferred embodiment, the said method is used in an electric vehicle with the said at least one electrical circuit being selected so that any interruption in its continuity leads to cutting off the electric current from the vehicle's driving electric motor(s).

In another feature, the said method further comprises providing at least one pressure-activated device that detects the hydrostatic pressure of a working fluid within the vehicle's brake system, with said pressure-activated device being constructed and configured to cause an interruption in the continuity of at least one electrical circuit that includes the said at least one position-sensing electronic device and at least one of the vehicle components once the hydrostatic pressure within the said brake system reaches a predetermined level. In a preferred embodiment, the said method is used in an electric vehicle with the said at least one electrical circuit being selected so that any interruption in its continuity leads to cutting off the electric current from the vehicle's driving electric motor(s).

In yet another feature, the said method further comprises providing a brake pedal actuated device constructed and configured to cause closure of an electrical circuit connected to at least one component of the vehicle's powertrain once the brake pedal reaches a predetermined position, with the said component of the vehicle's powertrain being constructed and configured to cause at least one component of the vehicle's powertrain to move to its idle operating position once the said electrical circuit is closed.

In another feature, the said method further comprises providing a pressure-activated device that detects the hydrostatic pressure of a working fluid within the vehicle's brake system, with said pressure-activated device being constructed and configured to cause closure of an electrical circuit connected to at least one component of the vehicle's powertrain once the hydrostatic pressure within the said brake system reaches a predetermined level, with the said component of the vehicle's powertrain being constructed and configured to cause at least one component of the vehicle's powertrain to move to its idle operating position once the said electrical circuit is closed.

In yet another feature, the said method further comprises detecting the position of the vehicle's brake pedal and generating signals accordingly, with said generated signals being processed along with said signals generated in correlation with said measured angle of inclination of the vehicle and said signals generated in correlation with said selected operating mode of the vehicle, and with said sent instructions being configured accordingly.

In another feature, the said method further comprises detecting the hydrostatic pressure of a working fluid within the vehicle's brake system and generating signals accordingly, with said generated signals being processed along with said signals generated in correlation with said measured angle of inclination of the vehicle and said signals generated in correlation with said selected operating mode of the vehicle, and with said sent instructions being configured accordingly.

In yet another feature, the said method further comprises measuring the speed of the said vehicle and generating signals accordingly, with said generated signals being processed along with said signals generated in correlation with said measured angle of inclination of the vehicle and said signals generated in correlation with said selected operating mode of the vehicle, and with said sent instructions being configured accordingly.

In still another feature, the said method further comprises measuring the weight of the vehicle and generating signals accordingly, with said generated signals being processed along with said signals generated in correlation with said measured angle of inclination of the vehicle and said signals generated in correlation with said selected operating mode of the vehicle, and with said sent instructions being configured accordingly.

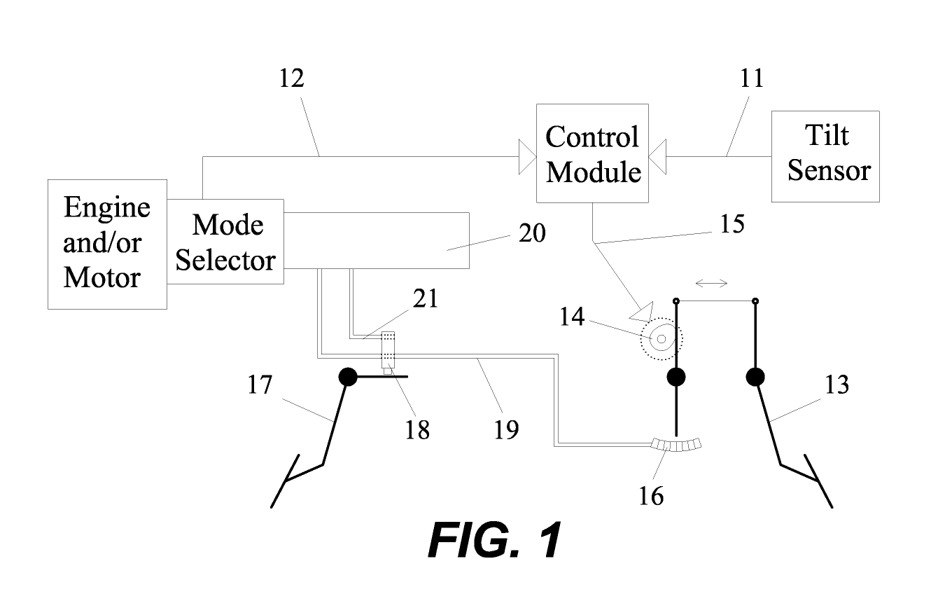

As shown in FIG. 1, which is a functional block diagram of a vehicle including a preferred embodiment of an anti-rollback control system in accordance with the present invention, the powertrain of the vehicle in which the anti-rollback control system is used includes an ICE and/or an electric motor (Engine and/or Motor); and an operating mode selecting device (Mode Selector). In this embodiment, the anti-rollback control system comprises: a Tilt

Sensor; a sensor that detects the selected operating mode of the vehicle (not shown in the drawing for simplicity); an automated position-adjusting device (14); and a Control Module, with the vehicle's accelerator pedal (13) being mechanically linked to a position-sensing electronic device (16).

Accordingly, on beginning/resuming the movement of the said vehicle after stopping it on an incline, the Tilt Sensor detects the angle of inclination of the vehicle's longitudinal axis with reference to the horizontal plane and sends signals (11) accordingly to the Control Module, and the sensor that detects the selected operating mode of the vehicle sends correlated signals (12) to the Control Module, with the Control Module being constructed and configured to receive the signals (11, 12) generated by the tilt sensor and the sensor for detecting the selected operating mode of the vehicle, process said received signals, and send instructions (15) accordingly to the automated position-adjusting device (14) to move a movable component of the position-sensing electronic device (16) to a predetermined position according to which a preset amount of fuel is supplied to the ICE and/or a preset amount of electric power is delivered to the electric motor, and hence a preset amount of mechanical power is generated by the said powertrain, with the said preset amount of mechanical power being sufficient to create a force, in the intended direction of movement of the vehicle, equivalent to, or bigger than, the gravitational force tending to roll the vehicle in the unwanted direction.

In this embodiment, the anti-rollback control system further comprises a brake pedal (17) actuated switch (18) constructed and configured to cause an interruption in the continuity of an electrical circuit (19) that includes the position-sensing electronic device (16) and at least one of the vehicle components (20), and to close another electrical circuit (21) connected to at least one of the vehicle components (20), once the brake pedal reaches a predetermined position, with the said vehicle component(s) being constructed and configured to cause at least one component of the vehicle's powertrain to move to its idle operating position once the electrical circuit (21) is closed. This arrangement enables disconnecting the position-sensing electronic device (16) from the vehicle's powertrain and to move at least one component of the vehicle's powertrain to its idle operating position, and hence bring the vehicle's energy consumption to its minimum idle level, when the vehicle brakes are applied.

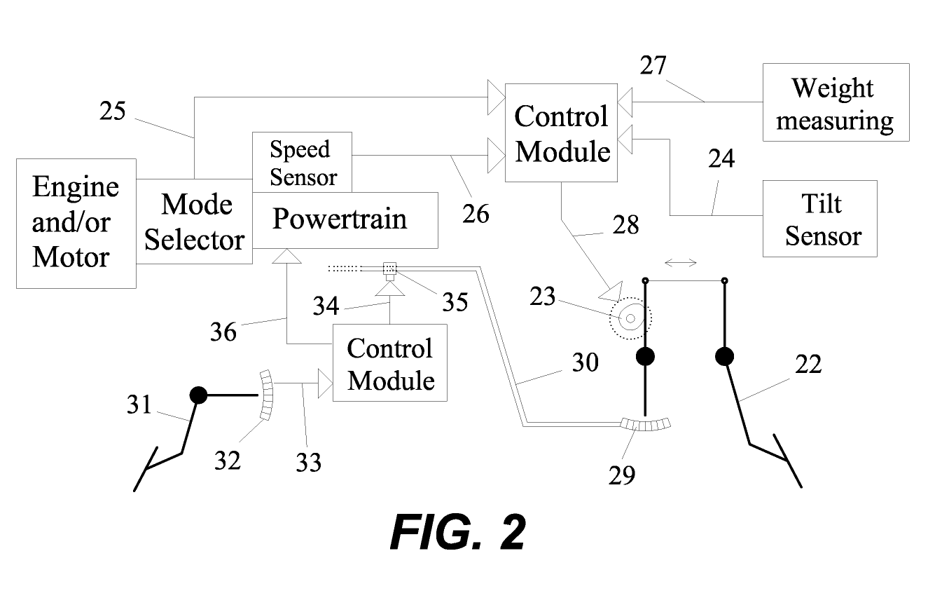

And as shown in FIG. 2, which is a functional block diagram of a vehicle including another preferred embodiment of an anti-rollback control system in accordance with the present invention, the powertrain of the vehicle in which the anti-rollback control system is used includes an ICE and/or an electric motor (Engine and/or Motor); and an operating mode selecting device (Mode Selector). In this embodiment, the anti-rollback control system comprises: a Tilt Sensor; a sensor that detects the selected operating mode of the vehicle (not shown in the drawing for simplicity); a Speed Sensor; a weight-measuring device; an automated position-adjusting device (23); and a Control Module, with the vehicle's accelerator pedal (22) being mechanically linked to a position-sensing electronic device (29).

Accordingly, on beginning/resuming the movement of the said vehicle after stopping it on an incline, the Tilt Sensor measures the angle of inclination of the vehicle's longitudinal axis with reference to the horizontal plane and sends signals (24) accordingly to the Control Module, the sensor that detects the selected operating mode of the vehicle sends correlated signals (25) to the Control Module, the Speed Sensor measures the speed of the vehicle and sends signals (26) accordingly to the Control Module, and the weight-measuring device measures the weight of the vehicle and sends signals (27) accordingly to the Control Module, with the Control Module being constructed and configured to receive the signals (24, 25, 26, 27) generated by the before mentioned sensors and devices, process said received signals, and send instructions (28) accordingly to the automated position-adjusting device (23) to adjust the position of a movable component of the position-sensing electronic device (29), as described herein above.

In this embodiment, the vehicle's brake pedal (31) is mechanically incorporated with a position sensor (32) that detects the position of the brake pedal and sends signals (33) accordingly to a Control Module, with the Control Module being constructed and configured to receive said signals, process them, and send instructions (34) to a solenoid actuated switch (35) constructed and configured to cause an interruption in the continuity of an electrical circuit (30) that includes the position-sensing electronic device (29) and at least one of the vehicle components, and to send instructions (36) to at least one component of the vehicle's powertrain to cause at least one component of the vehicle's powertrain to move to its idle operating position, once the brake pedal reaches a predetermined position.

This arrangement enables bringing the vehicle's energy consumption to its minimum idle level when the vehicle brakes are applied. Also, as the movement of the movable component(s) of the position-sensing electronic device, and hence the increase in the amount of mechanical power generated by the powertrain, is correlated with the gross weight of the vehicle, so the overall vehicle's energy consumption on operating the vehicle on an incline is brought down to a minimum. The use of the speed sensor in this preferred embodiment enables preventing the premature activation of the anti-rollback control system when the vehicle is cruising at, or above, a predetermined speed, with said speed being selected to suffice preventing the rollback of the vehicle on the incline, which prolongs the service life of the system.

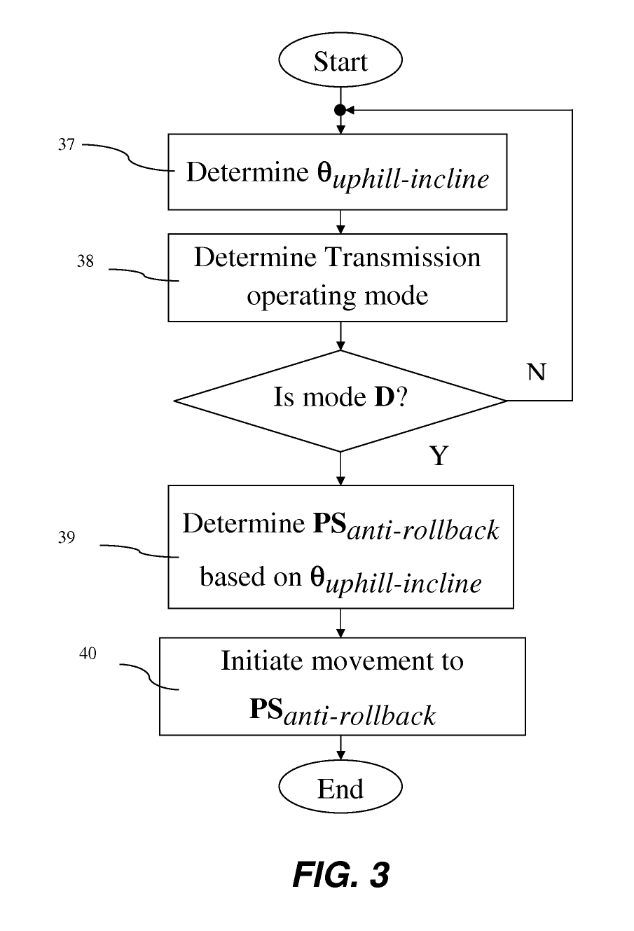

FIG. 3 is a flowchart illustrating exemplary steps executed by a control module in accordance with the present invention, with said control module being configured for use in a motor vehicle to prevent undesired backward rolling of the said vehicle on beginning/resuming its movement after stopping it on an uphill incline.

Accordingly, in step 37, the control module determines the uphill angle of inclination θ_{uphill-incline}, based on the signals received from a tilt sensor. In step 38, the control module determines the operating mode selected by the vehicle's operator. If the selected operating mode is not D, control module loops back to step 37. If the selected operating mode is D, control module determines the position of the position-sensing electronic device needed to prevent backward rolling of the vehicle PS_{anti-rollback} based on θ_{uphill-incline}, which is shown in step 39. In step 40, the control module sends signals to an automated position-adjusting device to initiate the movement of the position-sensing electronic device to PS_{anti-rollback} position and control ends.

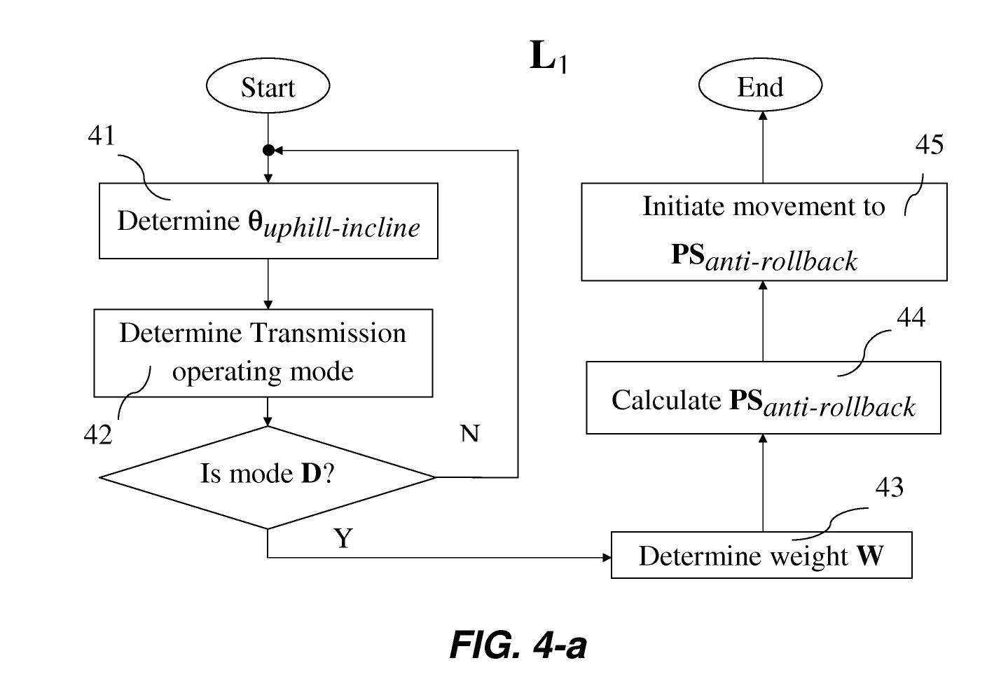

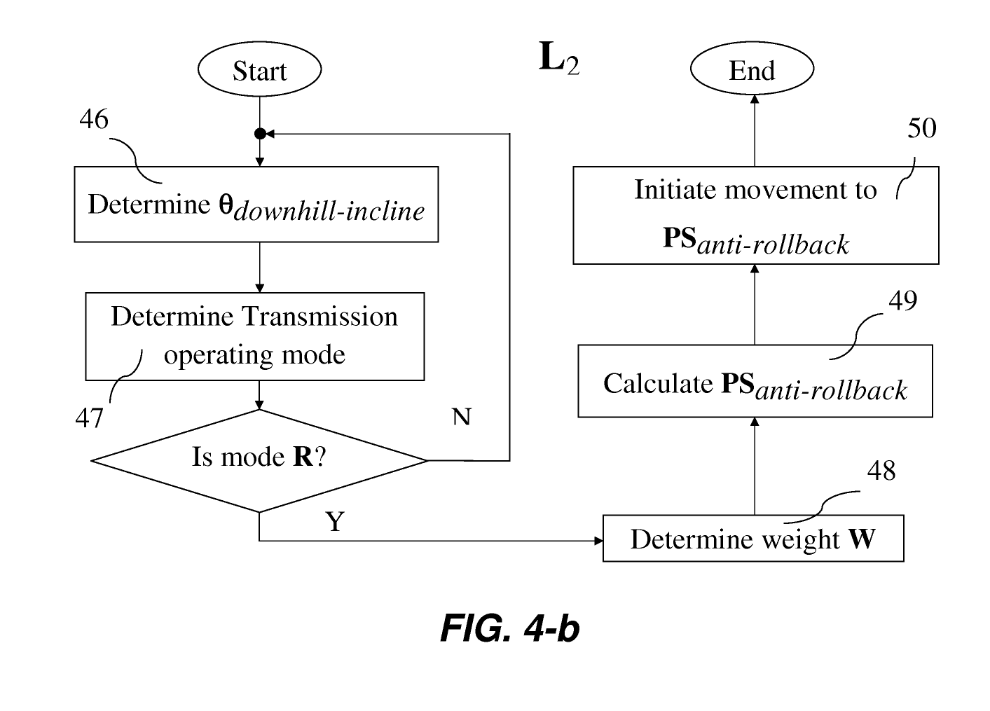

FIG. 4-a and FIG. 4-b are flowcharts illustrating exemplary steps executed by the layers of a multi-task control module in accordance with the present invention, with said control module being configured for use in a motor vehicle to prevent undesired backward rolling of the said vehicle on beginning/resuming its forward movement after stopping it on an uphill incline, and to prevent undesired forward rolling of the vehicle on beginning/resuming its backward movement after stopping it on a downhill incline.

In this exemplary embodiment, a multi-task, double-layered control module is employed, with one of its layers (L₁), which is shown in FIG. 4-a, being configured to operate when the angle of inclination measured by the tilt sensor indicates positioning of the vehicle on an uphill incline, i.e. θ_{uphill-incline,} and the selected vehicle's operating mode is D, and with the other layer (L₂), which is shown in FIG. 4-b, being configured to operate when the angle of inclination measured by the tilt sensor indicates positioning of the vehicle on a downhill incline, i.e. θ_{downhill-incline}, and the selected vehicle's operating mode is R.

Accordingly as shown in FIG. 4-a, on positioning the vehicle on an uphill incline, the first layer (L₁) of the control module is activated as follows. In step 41, the first layer (L₁) of the control module determines the uphill angle of inclination θ_{uphill-incline}, based on the signals received from a tilt sensor. In step 42, the control module determines the vehicle's operating mode selected by the vehicle's operator. If the selected operating mode is not D, control module loops back to step 41. If the selected operating mode is D, control module determines the weight of the vehicle W based on signals received from a weight-measuring device, which is shown in step 43. In step 44 the control module calculates the position of the position-sensing electronic device needed to prevent backward rolling of the vehicle PS_{anti-rollback}, based on W and θ_{uphill-incline}. In step 45, the control module sends signals to an automated position-adjusting device to initiate the movement of the position-sensing electronic device to PS_{anti-rollback} position and control ends.

And as shown in FIG. 4-b, on positioning the vehicle on a downhill incline, the second layer (L₂) of the control module is activated as follows. In step 46, the second layer (L₂) of the control module determines the downhill angle of inclination θ_{downhill-incline}, based on the signals received from a tilt sensor. In step 47, the control module determines the vehicle's operating mode selected by the vehicle's operator. If the selected operating mode is not R, control module loops back to step 46. If the selected operating mode is R, control module determines the weight of the vehicle W based on signals received from a weight-measuring device, which is shown in step 48. In step 49 the control module calculates the position of the position-sensing electronic device needed to prevent forward rolling of the vehicle PS_{anti-rollback}, based on W and θ_{downhill-incline}. In step 50, the control module sends signals to an automated position-adjusting device to initiate the movement of the position-sensing electronic device to PS_{anti-rollback} position and control ends.

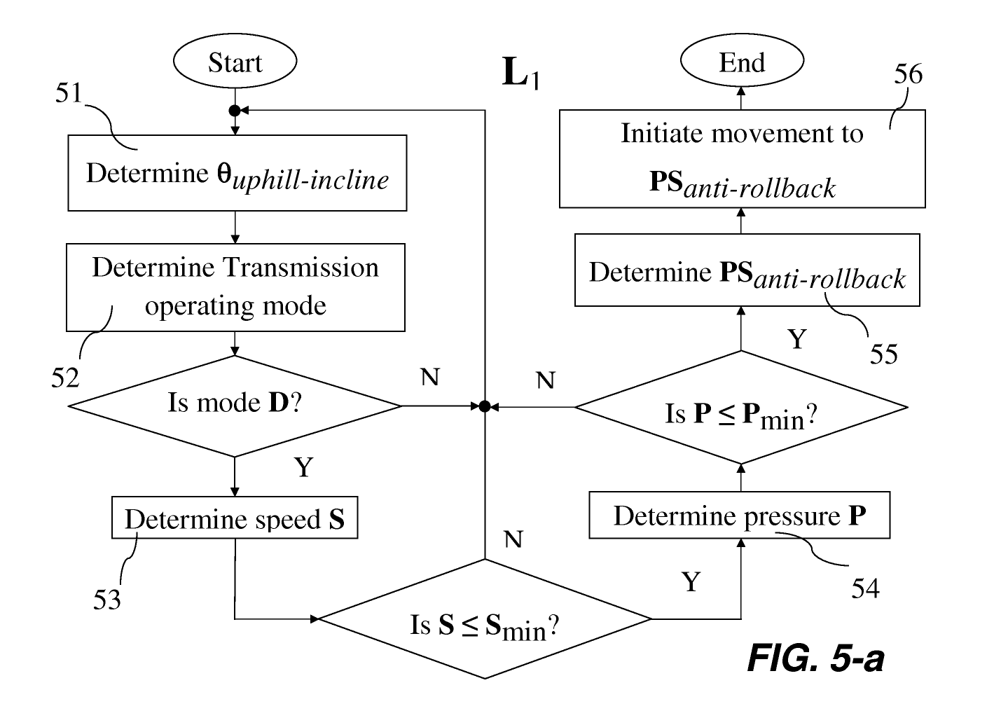

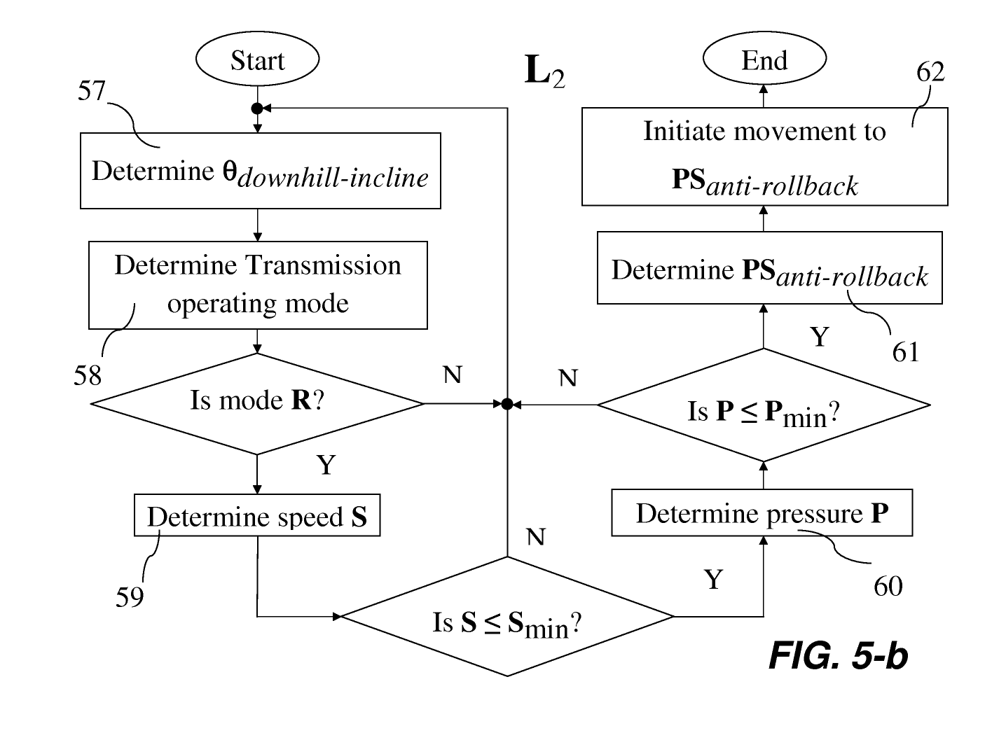

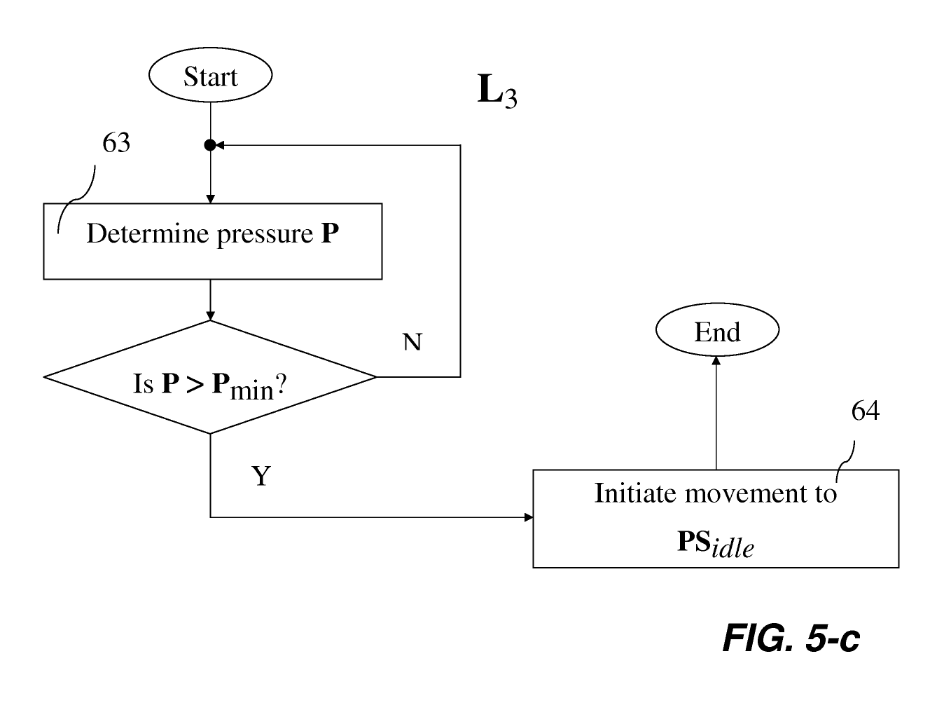

FIG. 5-a, FIG. 5-b, and FIG. 5-c are flowcharts illustrating exemplary steps executed by the layers of another multi-task control module in accordance with the present invention, with said control module being configured for use in a motor vehicle to prevent undesired backward rolling of the vehicle on beginning/resuming its forward movement after stopping it on an uphill incline, and to prevent undesired forward rolling of the vehicle on beginning/resuming its backward movement after stopping it on a downhill incline.

In this exemplary embodiment, a multi-task, three-layered control module is employed, with one of its layers (L₁), which is shown in FIG. 5-a, being configured to operate when the angle of inclination measured by the tilt sensor indicates positioning of the vehicle on an uphill incline, i.e. θ_{uphill-incline}, and the selected vehicle's operating mode is D, and with the other layer (L₂), which is shown in FIG. 5-b, being configured to operate when the angle of inclination measured by the tilt sensor indicates positioning of the vehicle on an downhill incline, i.e. θ_{downhill-incline}, and the selected vehicle's operating mode is R. The third layer (L₃), which is shown in FIG. 5-c, is configured to operate when the brake pedal is fully depressed with the hydrostatic pressure within the vehicle's brake system being above a threshold level Pₘᵢₙ.

Accordingly as shown in FIG. 5-a, on positioning the vehicle on an uphill incline, the first layer (L₁) of the control module is activated as follows. In step 51, the first layer (L₁) of the control module determines the uphill angle of inclination θ_{uphill-incline}, based on the signals received from a tilt sensor. In step 52, the control module determines the vehicle's operating mode selected by the vehicle's operator. If the selected operating mode is not D, control module loops back to step 51. If the selected operating mode is D, control module determines the speed of the vehicle S based on signals received from a speed sensor, which is shown in step 53. If the speed of the vehicle S is more than a threshold speed Sₘᵢₙ, control module loops back to step 51. If the speed of the vehicle is ≦Sₘᵢₙ, control module determines the hydrostatic pressure within the vehicle's brake system P based on signals received from a pressure sensor, which is shown in step 54. If the pressure level is higher than a threshold level Pₘᵢₙ, control module loops back to step 51. If the pressure level is ≦Pₘᵢₙ, control module determines the position of the position-sensing electronic device needed to prevent backward rolling of the vehicle PS_{anti-rollback}, based on θ_{uphill-incline}, which is shown in step 55. In step 56, the control module sends signals to an automated position-adjusting device to initiate the movement of the position-sensing electronic device to PS_{anti-rollback} position and control ends.

And as shown in FIG. 5-b, on positioning the vehicle on a downhill incline, the second layer (L₂) of the control module is activated as follows. In step 57, the second layer (L₂) of the control module determines the downhill angle of inclination θ_{downhill-incline}, based on the signals received from a tilt sensor. In step 58, the control module determines the vehicle's operating mode selected by the vehicle's operator. If the selected operating mode is not R, control module loops back to step 57. If the selected operating mode is R, control module determines the speed of the vehicle S based on signals received from a speed sensor, which is shown in step 59. If the speed of the vehicle S is more than a threshold speed Sₘᵢₙ, control module loops back to step 57. If the speed of the vehicle is ≦Sₘᵢₙ, control module determines the hydrostatic pressure within the vehicle's brake system P based on signals received from a pressure sensor, which is shown in step 60. If the pressure level is higher than a threshold level Pₙᵤₙ, control module loops back to step 57. If the pressure level is ≦Pₘᵢₙ, control module determines the position of the position-sensing electronic device needed to prevent forward rolling of the vehicle PS_{anti-rollback}, based on θ_{downhill-incline}, which is shown in step 61. In step 62, the control module sends signals to an automated position-adjusting device to initiate the movement of the position-sensing electronic device to PS_{anti-rollback} position and control ends.

And as shown in FIG. 5-c, when the brake pedal is fully depressed by the vehicle operator, the third layer (L₃) of the control module is activated as follows. In step 63, the third layer (L₃) of the control module determines the hydrostatic pressure within the vehicle's brake system P based on signals received from a pressure sensor. If the pressure level is less than a threshold level Pₘᵢₙ, control module loops back to the same step. If the pressure level is >Pₘᵢₙ, the control module sends signals to the automated position-adjusting device to initiate the movement of the position-sensing electronic device to idle position PS_{idle}, which is shown in step 64, and control ends.

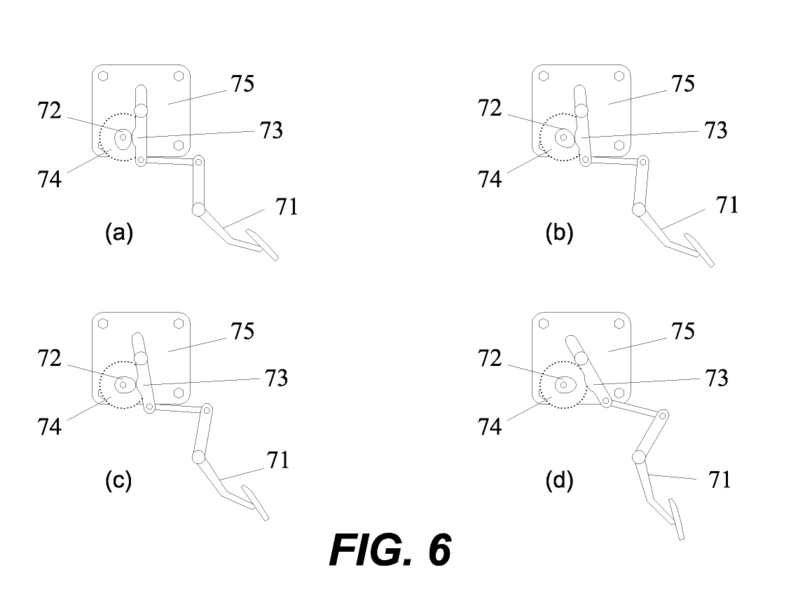

FIG. 6 shows a functional block diagram of an accelerator pedal (71) in a plurality of exemplary operating positions, in accordance with the anti-rollback control system of the present invention; wherein said anti-rollback control system includes an automated position-adjusting device and a control module.

In this exemplary embodiment, the automated position-adjusting device is mechanically linked to a position-sensing electronic device (75), and the accelerator pedal (71) is mechanically linked to the position-sensing electronic device (75), so that any movement of the automated position-adjusting device will be transmitted to both the position-sensing electronic device (75) and the accelerator pedal (71). The automated position-adjusting device comprises: a cam (72) and follower (73) mechanism; and a stepper motor (74), with the said follower (73) being linked to a movable component of the position-sensing electronic device (75) so that the movement of the follower is directly transmitted to the movable component of the position-sensing electronic device (75), and with the movement of the said cam and follower mechanism (72, 73), and hence the movement of the movable component(s) of the position-sensing electronic device (75), being controlled by the said stepper motor (74) in accordance with instructions sent by said control module. The movement of the movable component(s) of the position-sensing electronic device (75) and hence the movement of the accelerator pedal (71) ranges between an idle position (FIG. 6-a) and an operator-controlled fully depressed position (FIG. 6-d).

As shown in this figure, the operating range of the accelerator pedal (71) is functionally divided into two portions: a first anti-rollback control system influenced portion, which is the portion between the position of the accelerator pedal in FIG. 6-a and FIG. 6-c; and a second operator-controlled portion, which is the portion between the position of the accelerator pedal in FIG. 6-c and FIG. 6-d, noting that using a cam (72) and follower (73) mechanism allows the operator to fully control the whole operating range of the accelerator pedal when the automated position-adjusting device is idle.

And hence, on beginning/resuming the movement of the vehicle on an incline, the control module sends instructions to the stepper motor (74), to move the cam and follower mechanism (72, 73), and hence the movable component(s) of the position-sensing electronic device (75), to a predetermined position, lying anywhere between the position of the accelerator pedal in FIG. 6-a and its position in FIG. 6-c, according to which a preset amount of mechanical power is generated by the vehicle's powertrain, with said preset amount of mechanical power being sufficient to create a force, in the intended direction of movement of the vehicle, equivalent to, or bigger than, the gravitational force tending to roll the vehicle in the unwanted direction.

Once the operator starts to press the accelerator pedal (71), the cam and follower mechanism (72, 73) is disengaged, with the operator gaining full control of the accelerator pedal (71), as shown in (FIG. 6-d). Also, once the vehicle reaches a horizontal plane, the control module sends instructions to the stepper motor (74) to move the cam and follower mechanism (72, 73) to idle position (FIG. 6-a), so that the operator gains full control of the whole operating range of the accelerator pedal (71).

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. In a motor vehicle having an accelerator pedal that is mechanically incorporated with at least one position-sensing electronic device, an anti-rollback control system comprising:
at least one tilt sensor that detects an angle of inclination of the vehicle's longitudinal axis with reference to the horizontal plane and generates signals accordingly; at least one sensor for detecting a selected operating mode of the vehicle and generating signals accordingly; at least one automated position-adjusting device for adjusting the position of at least one movable component of the said at least one position-sensing electronic device; and a control module constructed and configured for receiving the signals generated by the at least one sensor relating to tilt and the at least one sensor for detecting the selected operating mode of the vehicle, processing said received signals, and sending instructions accordingly to the said at least one automated position-adjusting device to cause at least one movable component of the said at least one position-sensing electronic device to move to a predetermined position according to which a predetermined corresponding amount of mechanical power is generated by the vehicle's powertrain, with said predetermined amount of mechanical power being sufficient to create a force, in the intended direction of movement of the vehicle, equivalent to, or bigger than, the gravitational force tending to roll the vehicle in the unwanted direction.

2. The anti-rollback control system of claim 1, wherein the said position-sensing electronic device is a potentiometer.

3. The anti-rollback control system of claim 1, wherein the said at least one automated position-adjusting device is mechanically incorporated with the said at least one position-sensing electronic device.

4. The anti-rollback control system of claim 1, wherein the said control module is constructed and configured to send instructions to move the said at least one automated position-adjusting device to its idle position when the said received signals indicate selecting a non-moving operating mode by the vehicle operator.

5. The anti-rollback control system of claim 1, wherein the said control module is constructed and configured to send instructions to move the said at least one automated position-adjusting device to its idle position when the said signals received from the said at least one tilt sensor indicate operating the vehicle on a horizontally oriented surface.

6. The anti-rollback control system of claim 1, which further comprises at least one brake pedal actuated device constructed and configured to cause an interruption in the continuity of at least one electrical circuit that includes the said at least one position-sensing electronic device and at least one of the vehicle components once the brake pedal reaches a predetermined position.

7. The anti-rollback control system of claim 6, wherein the said brake pedal actuated device is an electrical switch.

8. The anti-rollback control system of claim 6, wherein the said brake pedal actuated device includes a first brake pedal actuated electrical switch; a second solenoid actuated switch;
and a second electrical circuit that connects the first brake pedal actuated electrical switch to the second solenoid actuated switch, with the first brake pedal actuated electrical switch being constructed and configured to close the said second electrical circuit once the brake pedal reaches a predetermined position, and with the second solenoid actuated switch being constructed and configured to open the said at least one electrical circuit including the said at least one position-sensing electronic device and at least one of the vehicle components once the second electrical circuit is closed.

9. The anti-rollback control system of claim 6, wherein the said brake pedal actuated device comprises a position sensor that detects a position of the brake pedal and generates signals accordingly; a control module; and at least one solenoid actuated switch included within the said at least one electrical circuit, with the said control module being constructed and configured to receive the signals generated by said position sensor, process said received signals, and send instructions to said at least one solenoid actuated switch to open the said at least one electrical circuit including the said at least one position-sensing electronic device and at least one of the vehicle components once the brake pedal reaches a predetermined position.

10. The anti-rollback control system of claim 6 which is used in an electric vehicle, with the said at least one electrical circuit being selected so that any interruption in its continuity leads to cutting off the electric current from the vehicle,'s driving electric motor(s).

11. The anti-rollback control system of claim 1, which further comprises at least one pressure-activated device that detects the hydrostatic pressure of a working fluid within the vehicle's brake system, with the said at least one pressure-activated device being constructed and configured to cause an interruption in the continuity of at least one electrical circuit that includes the said at least one position-sensing electronic device and at least one of the vehicle components once the hydrostatic pressure within the said brake system reaches a predetermined level.

12. The anti-rollback control system of claim 11, wherein the said pressure-activated device actuates an electrical switch that causes an interruption in the continuity of the said at least one electrical circuit that includes the said at least one position-sensing electronic device and at least one of the vehicle components once the hydrostatic pressure within the said brake system reaches a predetermined level.

13. The anti-rollback control system of claim 11, wherein the said pressure-activated device actuates a first electrical switch constructed and configured to close a second electrical circuit once the hydrostatic pressure within the said brake system reaches a predetermined level, with the said second electrical circuit being connected to a second solenoid actuated switch constructed and configured to open the said at least one electrical circuit including the said at least one position-sensing electronic device and at least one of the vehicle components once the said second electrical circuit is closed.

14. The anti-rollback control system of claim 11, wherein the said pressure-activated device includes a pressure sensor that detects the hydrostatic pressure of a working fluid within the vehicle's brake system and generates signals accordingly; a control module; and at least one solenoid actuated switch included within the said at least one electrical circuit, with the said control module being constructed and configured to receive the signals generated by said pressure sensor, process said received signals, and send instructions to said at least one solenoid actuated switch to open the said at least one electrical circuit including the said at least one position-sensing electronic device and at least one of the vehicle components once the hydrostatic pressure within the said brake system reaches a predetermined level.

15. The anti-rollback control system of claim 11 which is used in an electric vehicle, with the said at least one electrical circuit being selected so that any interruption in its continuity leads to cutting off the electric current from the vehicle,' s driving electric motor(s).

16. The anti-rollback control system of claim 1, which further comprises a brake pedal actuated device constructed and configured to cause closure of an electrical circuit connected to at least one component of the vehicle's powertrain once the brake pedal reaches a predetermined position, with the said component of the vehicle's powertrain being constructed and configured to cause at least one component of the vehicle's powertrain to move to its idle operating position once the said electrical circuit is closed.

17. The anti-rollback control system of claim 16, wherein the said brake pedal actuated device is an electrical switch constructed and configured to close the said electrical circuit connected to at least one component of the vehicle's powertrain once the brake pedal reaches a predetermined position.

18. The anti-rollback control system of claim 16, wherein the said brake pedal actuated device includes a first brake pedal actuated electrical switch; a second solenoid actuated switch; and a second electrical circuit that connects the first brake pedal actuated electrical switch to the second solenoid actuated switch, with the first brake pedal actuated electrical switch being constructed and configured to close the said second electrical circuit once the brake pedal reaches a predetermined position, and with the second solenoid actuated switch being constructed and configured to close the said electrical circuit connected to at least one component of the vehicle's powertrain once the second electrical circuit is closed.

19. The anti-rollback control system of claim 16, wherein the said brake pedal actuated device comprises a position sensor that detects a position of the brake pedal and generates signals accordingly; a control module; and a solenoid actuated switch included within the said electrical circuit, with the said control module being constructed and configured to receive the signals generated by said position sensor, process said received signals, and send instructions to said solenoid actuated switch to close the said electrical circuit connected to at least one component of the vehicle's powertrain once the brake pedal reaches a predetermined position.

20. The anti-rollback control system of claim 1, which further comprises a pressure-activated device that detects the hydrostatic pressure of a working fluid within the vehicle's brake system, with said pressure-activated device being constructed and configured to cause closure of an electrical circuit connected to at least one component of the vehicle's powertrain once the hydrostatic pressure within the said brake system reaches a predetermined level, with the said component of the vehicle's powertrain being constructed and configured to cause at least one component of the vehicle's powertrain to move to its idle operating position once the said electrical circuit is closed.

21. The anti-rollback control system of claim 20, wherein the said pressure-activated device actuates an electrical switch constructed and configured to close the said electrical circuit connected to at least one component of the vehicle's powertrain once the hydrostatic pressure within the said brake system reaches a predetermined level.

22. The anti-rollback control system of claim 20, wherein the said pressure-activated device actuates a first electrical switch constructed and configured to close a second electrical circuit once the hydrostatic pressure within the said brake system reaches a predetermined level, with the said second electrical circuit being connected to a second solenoid actuated switch constructed and configured to close the said electrical circuit connected to at least one component of the vehicle's powertrain once the said second electrical circuit is closed.

23. The anti-rollback control system of claim 20, wherein the said pressure-activated device includes a pressure sensor that detects the hydrostatic pressure of a working fluid within the vehicle's brake system and generates signals accordingly; a control module; and a solenoid actuated switch included within the said electrical circuit, with the said control module being constructed and configured to receive the signals generated by said pressure sensor, process said received signals, and send instructions to said solenoid actuated switch to close the said electrical circuit connected to at least one component of the vehicle's powertrain once the hydrostatic pressure within the said brake system reaches a predetermined level.

24. The anti-rollback control system of claim 1, which further comprises at least one sensor that detects the position of the vehicle's brake pedal and sends signals accordingly to said control module, with said control module being constructed and configured to begin sending said instructions to the said at least one automated position-adjusting device once the brake pedal reaches a predetermined position.

25. The anti-rollback control system of claim 24, wherein the said predetermined brake pedal position at which said control module is configured to begin sending said instructions to the at least one automated position-adjusting device is determined in correlation with the said measured angle of inclination.

26. The anti-rollback control system of claim 24, wherein the control module is configured to send signals to move the at least one automated position-adjusting device to its idle position once the brake pedal reaches a predetermined position.

27. The anti-rollback control system of claim 1, which further comprises at least one sensor that detects the hydrostatic pressure of a working fluid at at least one point within the vehicle's brake system and sends signals accordingly to said control module, with said control module being constructed and configured to begin sending the said instructions to the said at least one automated position-adjusting device once the hydrostatic pressure within the vehicle's brake system drops to a predetermined level.

28. The anti-rollback control system of claim 27, wherein the said predetermined brake pressure level at which said control module is configured to begin sending said instructions to the at least one automated position-adjusting device is determined in correlation with the said measured angle of inclination.

29. The anti-rollback control system of claim 27, wherein the control module is configured to send signals to move the at least one automated position-adjusting device to its idle position once the hydrostatic pressure within the vehicle's brake system reaches a predetermined level.

30. The anti-rollback control system of claim 1, wherein the vehicle's maximum loading weight is being taken into account while processing said received signals by said control module.

31. The anti-rollback control system of claim 1, which further comprises at least one sensor for generating a signal indicative of a speed of said vehicle and sending signals accordingly to said control module, with said control module being constructed and configured for processing the received signals, along with said signals received from said tilt sensor and said sensor for detecting the selected operating mode of the vehicle, and sending instructions accordingly to the said at least one automated position-adjusting device.

32. The anti-rollback control system of claim 1, which further comprises at least one weight-measuring device that measures the weight of said vehicle and sends signals accordingly to said control module, with said control module being constructed and configured for processing the received signals, along with said signals received from said tilt sensor and said sensor for detecting the selected operating mode of the vehicle, and sending instructions accordingly to the said at least one automated position-adjusting device.

33. The anti-rollback control system of claim 32, wherein the said weight-measuring device is a load cell.

34. The anti-rollback control system of claim 1, wherein the said at least one automated position-adjusting device includes: a cam and follower mechanism; and a stepper motor, with the said follower being mechanically incorporated with at least one movable component of the said at least one position-sensing electronic device, and with the movement of the said cam and follower mechanism being controlled by the said stepper motor in accordance with said instructions sent by said control module.

35. The anti-rollback control system of claim 1, wherein said signals generated by said tilt sensor and received by said control module are repeated at equal intervals.

36. The anti-rollback control system of claim 1, wherein the control module is a multi-task module.

37. The anti-rollback control system of claim 1, which is used in a motor vehicle having an Electronic Control Unit (ECU), with the said control module being integrated within the said ECU.

38. The anti-rollback control system of claim 1, which is functional for preventing undesired backward rolling of said vehicle on beginning/resuming its forward movement after stopping it on an uphill incline.

39. The anti-rollback control system of claim 1, which is functional for preventing undesired forward rolling of said vehicle on beginning/resuming its backward movement after stopping it on a downhill incline.

40. The anti-rollback control system of claim 1, which is operable for preventing undesired rolling of said vehicle on anyone of a number of inclines, with each of the said inclines having a different angle of inclination, wherein each individual angle of inclination measured by the said tilt sensor, on operating the vehicle on each of the said inclines, is being correlated with a different set of instructions sent by said control module.

41. The anti-rollback control system of claim 1, which is operable for preventing undesired rolling of said vehicle on anyone of a number of inclines, with each of the said inclines having a different angle of inclination, and with the angles of inclinations of the said inclines being functionally grouped into at least one range of angles, wherein each individual angle of inclination measured by the said tilt sensor, on operating the vehicle on each of the said inclines, is being correlated with a predetermined set of instructions sent by said control module based on the range of angles within which said measured angle of inclination lies.

42. In a motor vehicle having an accelerator pedal that is mechanically incorporated with at least one position-sensing electronic device, a method for preventing undesired rolling of the said vehicle on an incline, said method comprises: providing an automated device for adjusting the position of at least one movable component of the said at least one position-sensing electronic device; measuring the angle of inclination of the vehicle's longitudinal axis with reference to the horizontal plane and generating signals accordingly; detecting the selected operating mode of the vehicle and generating signals accordingly; processing said generated signals; and sending instructions accordingly to said automated device provided for adjusting the position of at least one movable component of the said at least one position-sensing electronic device.

43. The method of claim 42, which further comprises providing at least one brake pedal actuated device constructed and configured to cause an interruption in the continuity of at least one electrical circuit that includes the said at least one position-sensing electronic device and at least one of the vehicle components once the brake pedal reaches a predetermined position.

44. The method of claim 43 which is used in an electric vehicle, with the said at least one electrical circuit being selected so that any interruption in its continuity leads to cutting off the electric current from the vehicle's driving electric motor(s).

45. The method of claim 42, which further comprises providing at least one pressure-activated device that detects the hydrostatic pressure of a working fluid within the vehicle's brake system, with said pressure-activated device being constructed and configured to cause an interruption in the continuity of at least one electrical circuit that includes the said at least one position-sensing electronic device and at least one of the vehicle components once the hydrostatic pressure within the said brake system reaches a predetermined level.

46. The method of claim 45 which is used in an electric vehicle, with the said at least one electrical circuit being selected so that any interruption in its continuity leads to cutting off the electric current from the vehicle's driving electric motor(s).

47. The method of claim 42, which further comprises providing a brake pedal actuated device constructed and configured to cause closure of an electrical circuit connected to at least one component of the vehicle's powertrain once the brake pedal reaches a predetermined position, with the said component of the vehicle's powertrain being constructed and configured to cause at least one component of the vehicle's powertrain to move to its idle operating position once the said electrical circuit is closed.

48. The method of claim 42, which further comprises providing a pressure-activated device that detects the hydrostatic pressure of a working fluid within the vehicle's brake system, with said pressure-activated device being constructed and configured to cause closure of an electrical circuit connected to at least one component of the vehicle's powertrain once the hydrostatic pressure within the said brake system reaches a predetermined level, with the said component of the vehicle's powertrain being constructed and configured to cause at least one component of the vehicle's powertrain to move to its idle operating position once the said electrical circuit is closed.

49. The method of claim 42, which further comprises detecting the position of the vehicle's brake pedal and generating signals accordingly, with said generated signals being processed along with said signals generated in correlation with said measured angle of inclination of the vehicle and said signals generated in correlation with said selected operating mode of the vehicle, and with said sent instructions being configured accordingly.

50. The method of claim 42, which further comprises detecting the hydrostatic pressure of a working fluid within the vehicle's brake system and generating signals accordingly, with said generated signals being processed along with said signals generated in correlation with said measured angle of inclination of the vehicle and said signals generated in correlation with said selected operating mode of the vehicle, and with said sent instructions being configured accordingly.

51. The method of claim 42, which further comprises measuring the speed of the said vehicle and generating signals accordingly, with said generated signals being processed along with said signals generated in correlation with said measured angle of inclination of the vehicle and said signals generated in correlation with said selected operating mode of the vehicle, and with said sent instructions being configured accordingly.

52. The method of claim 42, which further comprises measuring the weight of the vehicle and generating signals accordingly, with said generated signals being processed along with said signals generated in correlation with said measured angle of inclination of the vehicle and said signals generated in correlation with said selected operating mode of the vehicle, and with said sent instructions being configured accordingly.
